(19) United States
(12) Patent Application Publication
(10) Pub. No.: US 2025/0315591 A1
(43) Pub. Date: Oct. 9, 2025

(54) Financial Spreadsheet Modeling System

(71) Applicant: Firebird Labs USA, Inc., Beverly Hills, CA (US)

(72) Inventors: Nicholas Boris Lebedeff, Beverly Hills, CA (US); Alexander Canovas, Granada Hills, CA (US); Gerardo Gonzalez Uscanga, Mexico City (MX)

(73) Assignee: Firebird Labs USA, Inc., Beverly Hills, CA (US)

(21) Appl. No.: 19/097,205

(22) Filed: Apr. 1, 2025

Related U.S. Application Data
(60) Provisional application No. 63/631,144, filed on Apr. 8, 2024.

(51) Int. Cl. G06F 40/103; G06F 40/18

(52) U.S. Cl. CPC G06F 40/103; G06F 40/18

(57) ABSTRACT

A financial spreadsheet modeling system and associated methods are disclosed for securely creating and managing at least one financial spreadsheet. In at least one embodiment, a user application residing in memory on a computing device combines a model file and a data file to create a rendered report file containing a plurality of cells arranged as a plurality of rows and columns, with each row of the rendered report file containing a line number and a line description from a corresponding line of the model file, each cell within a given row of the rendered report file containing cell data from a corresponding line of the data file, and the cell data of each cell within a given row of the rendered report file being modified based on row logic from a corresponding line of the model file.

### RELATED APPLICATIONS

This application claims priority and is entitled to the filing date of U.S. provisional application Ser. No. 63/631,144, filed on Apr. 8, 2024. The contents of the aforementioned application are incorporated herein by reference.

### BACKGROUND

The subject of this patent application relates generally to spreadsheets, and more particularly to a financial spreadsheet modeling system configured for securely creating and managing an at least one financial spreadsheet.

Applicant(s) hereby incorporate herein by reference any and all patents and published patent applications cited or referred to in this application.

By way of background, Microsoft Excel is the leading tool for creating and managing financial spreadsheets. However, errors are extremely common in these spreadsheets, costing companies billions of dollars each year. F1F9, a financial modeling consulting firm, estimated that 88% of all spreadsheets have errors in them, and 50% of spreadsheets at large companies contain material defects. These faults stem from human error as well as Excel's shortcomings. Today, there are many different spreadsheet applications, with two of the most popular being Microsoft Excel and Google Sheets. Despite their differences, all of these spreadsheet applications are similar in their fundamental structure, in which spreadsheet cells are viewed individually, and formulas and functions are combined with data in the same spreadsheet; and it is that fundamental structure that can lead to issues like overwriting and errors, along with being susceptible to tampering and data falsification.

Accordingly, there remains a need for a spreadsheet management system that is capable of keeping spreadsheet data separate from spreadsheet formulas and functions to be performed on that data, so as to minimize overwriting and errors, simplify the export of logic to other spreadsheets, and better prevent tampering and data falsification; thus, creating a safer, more standardized financial modeling software that will not only save companies billions of dollars and make analysts' jobs easier, but will also aid regulators in preventing fraud. Aspects of the present invention fulfill these needs and provide further related advantages as described in the following summary.

It should be noted that the above background description includes information that may be useful in understanding aspects of the present invention. It is not an admission that any of the information provided herein is prior art or relevant to the presently claimed invention, or that any publication specifically or implicitly referenced is prior art.

### SUMMARY

Aspects of the present invention teach certain benefits in construction and use which give rise to the exemplary advantages described below.

The present invention solves the problems described above by providing a financial spreadsheet modeling system and associated methods for securely creating and managing an at least one financial spreadsheet containing a plurality of cells arranged as a plurality of rows and columns, with each cell containing cell data. In at least one embodiment, a user application resides in memory on an at least one computing device, the at least one computing device configured for receiving and processing select data related to the at least one financial spreadsheet. For each of the at least one financial spreadsheet, the user application creates a definition file containing a plurality of lines, with each line corresponding to a row of the financial spreadsheet and containing a line number, a line description, and a row logic to be applied to each cell in the corresponding row of the financial spreadsheet. The user application validates the definition file to confirm that the line number, line description and row logic contained in each line of the definition file uses proper syntax and line references, and then saves the definition file as a read-only model file. The user application also creates a data query file containing a plurality of lines, with each line corresponding to a row of the financial spreadsheet and containing a line number and cell data for each cell in the corresponding row of the financial spreadsheet, such that a given line of each of the data query file and definition file corresponding to the same row of the financial spreadsheet shares the same line number. The user application populates the cell data in the data query file. The user application validates the data query file to confirm that the cell data contained in each line of the data query file is valid, and then saves the data query file as a read-only data file. The user application then combines the model file and the data file to create a rendered report file containing a plurality of cells arranged as a plurality of rows and columns, with each row of the rendered report file containing the line number and line description from the corresponding line of the model file, each cell within a given row of the rendered report file containing the cell data from the corresponding line of the data file, and the cell data of each cell within a given row of the rendered report file being modified based on the row logic from the corresponding line of the model file.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a simplified schematic view of an exemplary financial spreadsheet modeling system, in accordance with at least one embodiment;

FIG. 2 is an illustration of an exemplary financial spreadsheet, in accordance with at least one embodiment;

FIG. 3 is an architecture diagram of an exemplary definition file, in accordance with at least one embodiment;

FIG. 4 is an architecture diagram of an exemplary data query file, in accordance with at least one embodiment;

FIG. 5 is a flow diagram of an exemplary method for creating an at least one financial spreadsheet, in accordance with at least one embodiment;

FIG. 6 is an illustration of an exemplary user interface, as displayed by an exemplary user device, containing an exemplary data query prolog module, in accordance with at least one embodiment; and

FIG. 7 is an illustration of an exemplary user interface, as displayed by an exemplary user device, containing an exemplary spreadsheet audit report, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

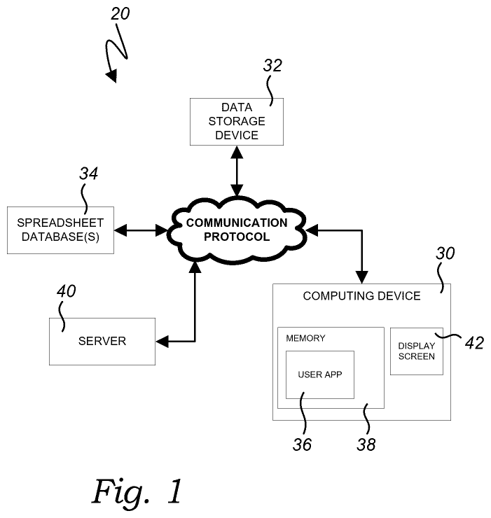

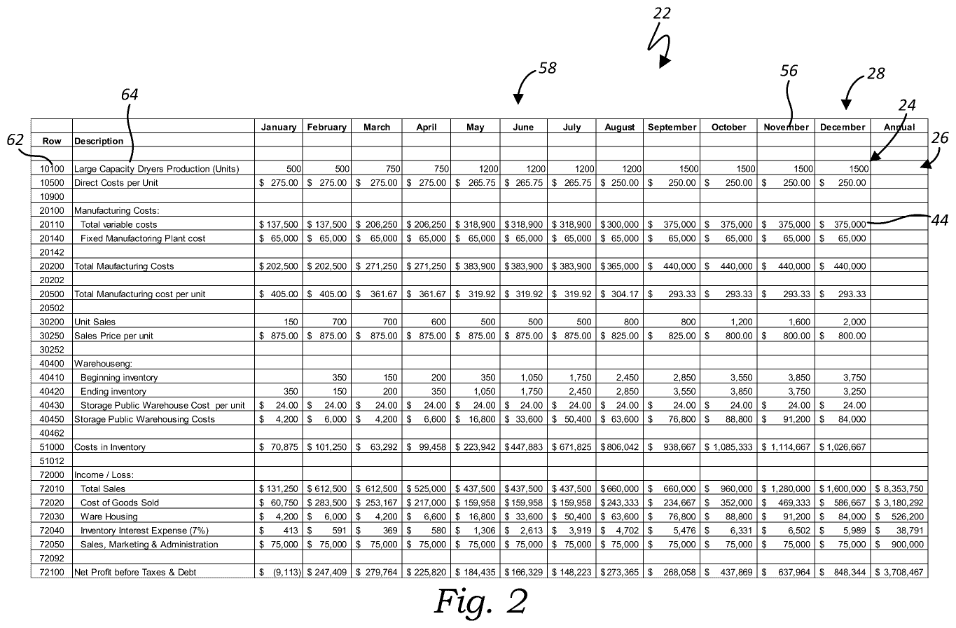

Turning now to FIG. 1, there is shown a simplified schematic view of an exemplary embodiment of a financial spreadsheet 22 modeling system 20 configured for securely creating and managing an at least one financial spreadsheet 22 (FIG. 2). At the outset, it should be noted that the term “spreadsheet 22” as used herein is intended to include any type of data structure configured for organizing, storing, manipulating and analyzing data in a tabular format—i.e., with the data stored in individual cells 24, and the cells 24 arranged as a plurality of rows 26 and columns 28—allowing for calculations, data sorting, and the creation of charts and graphs. Thus, the system 20 may be utilized in virtually any situation where there is a desire to create and manage a spreadsheet 22, even though certain specific spreadsheets 22 may be shown and described herein for illustrative purposes.

In at least one embodiment, the system 20 provides a computing device 30 configured for receiving and processing select data related to the at least one spreadsheet 22, as discussed further below. In at least one embodiment, the system 20 further provides an at least one data storage device 32 in selective communication with the computing device 30 and configured for storing said data related to the at least one spreadsheet 22. In at least one embodiment, the computing device 30 and data storage device 32 are one and the same—as such, it is intended that those terms as used herein are to be interchangeable with one another. In at least one embodiment, the computing device 30 is also in selective communication with an at least one spreadsheet database 34 containing select data that can be utilized by the computing device 30 in securely creating and managing the at least one financial spreadsheet 22, as discussed further below. In at least one embodiment, the at least one spreadsheet database 34 is stored on the at least one data storage device 32. In at least one alternate embodiment, the at least one spreadsheet database 34 is in the possession or under the control of a third party.

In at least one embodiment, the computing device 30 contains the hardware and software necessary to carry out the exemplary methods for securely creating and managing the at least one financial spreadsheet 22, as described herein. Furthermore, in at least one embodiment, the computing device 30 comprises a plurality of computing and/or electronic devices selectively working in concert with one another to carry out the exemplary methods for securely creating and managing the at least one financial spreadsheet 22, as described herein. In at least one embodiment, the computing device 30 provides a user application 36 residing locally in memory 38 on the computing device 30 (for example, as a standalone application on the computing device 30), the user application 36 being configured for selectively communicating with the computing device 30, as discussed further below. In at least one alternate embodiment, the functionality provided by the user application 36 resides remotely in memory on a server 40 in communication with the computing device 30, with the computing device 30 capable of accessing said functionality via an online portal hosted by (or at least in communication with) the system 20, either in addition to or in lieu of the user application 36 residing locally in memory 38 on the computing device 30. It should be noted that the term “memory” is intended to include any type of electronic storage medium (or combination of storage mediums) now known or later developed, such as local hard drives, RAM, flash memory 38, secure digital (“SD”) cards, external storage devices, network or cloud storage devices, integrated circuits, etc. Additionally, in at least one embodiment, the computing device 30 is in the possession or under the control of a user who is desirous of utilizing the system 20 to securely create and manage the at least one financial spreadsheet 22.

It should also be noted that communication between each of the computing device 30, data storage device 32, spreadsheet database 34, and server 40 may be achieved using any wired- or wireless-based communication protocol (or combination of protocols) now known or later developed. As such, the present invention should not be read as being limited to any one particular type of communication protocol, even though certain exemplary protocols may be mentioned herein for illustrative purposes. Similarly, in at least one embodiment, communications between each of the computing device 30, data storage device 32, and spreadsheet database 34 may be encrypted using any encryption method (or combination of methods) now known or later developed. It should also be noted that the term “computing device 30” is intended to include any type of computing or electronic device, now known or later developed, capable of substantially carrying out the functionality described herein—such as server 40 computers, desktop computers, mobile phones, smartphones, laptop computers, tablet computers, personal data assistants, gaming devices, wearable devices, etc. As such, the system 20 should not be read as being limited to use with any one particular type of computing or electronic device, even though certain exemplary computing devices may be mentioned or shown herein for illustrative purposes.

It also should be noted that, for simplicity purposes, the functionality provided by the user application 36 will be described herein as such—even though certain embodiments may provide said functionality through an online portal. It should also be noted that, for simplicity purposes, when discussing functionality and the various methods that may be carried out by the system 20 herein, the terms “computing device,” “user application” and “server” are intended to be interchangeable. In that regard, in at least one further embodiment, the computing device 30 and server 40 are one and the same. With continued reference to FIG. 1, in at least one embodiment, the computing device 30 provides an at least one display screen 42 for providing an at least one graphical user interface to assist the associated user with accessing and utilizing the various functions provided by the system 20.

As discussed in detail below, in at least one embodiment, a primary distinction and advantage provided by the system 20, as compared to known prior art, is that the system 20 keeps separate the data contained in the cells 24 of the spreadsheet 22 (hereinafter referred to generally as “cell data 44” for simplicity purposes) and the logic (i.e., functions/formulas) applied to that data (hereinafter referred to generally as “row logic 46” for simplicity purposes), rather than comingling the cell data 44 and corresponding row logic 46 within the same cells 24 as known prior art spreadsheet 22 solutions do, which can lead to potential errors through erroneously overwriting row logic 46 with cell data 44 and vice versa. Additionally, in at least one embodiment, as also discussed further below, to further reduce the number of potential errors which can be made when manually entering row logic 46, the system 20 applies row logic 46 for an entire row 26 of cells 24, rather than the typical cell-by-cell approach taken by known prior art spreadsheet 22 solutions. In at least one embodiment, as also discussed further below, the system 20 further improves upon known prior art spreadsheet 22 solutions by automatically totaling the cell data 44 of each cell 24 in a given column 28 of the spreadsheet 22 using a desired totaling row logic 46 (e.g., summation, average, custom formula, etc.), rather than requiring the user to manually select the specific cells 24 to be totaled as known prior art spreadsheet 22 solutions do, which can lead to accidental omissions or inclusions of cells 24 and, in turn, erroneous totaling results. Additionally, in at least one embodiment, as also discussed further below, the system 20 simplifies the process of auditing the spreadsheet 22 by providing an audit function that translates the row logic 46 for each row 26 of the spreadsheet 22 into user-friendly descriptions.

In at least one embodiment, to achieve the above-noted benefits, the computing device 30 creates, stores and manages a plurality of spreadsheet data files for the at least one spreadsheet 22 containing select data for assisting the computing device 30 with securely creating and managing the at least one spreadsheet 22, as discussed further below. In that regard, it should be noted that while the terms “file,” “record” and/or “table” are used herein to describe certain exemplary data structures, in at least one embodiment, any other suitable data type or data structure, or combinations thereof, now known or later developed, capable of storing the appropriate data, may be substituted. Thus, the present invention should not be read as being so limited.

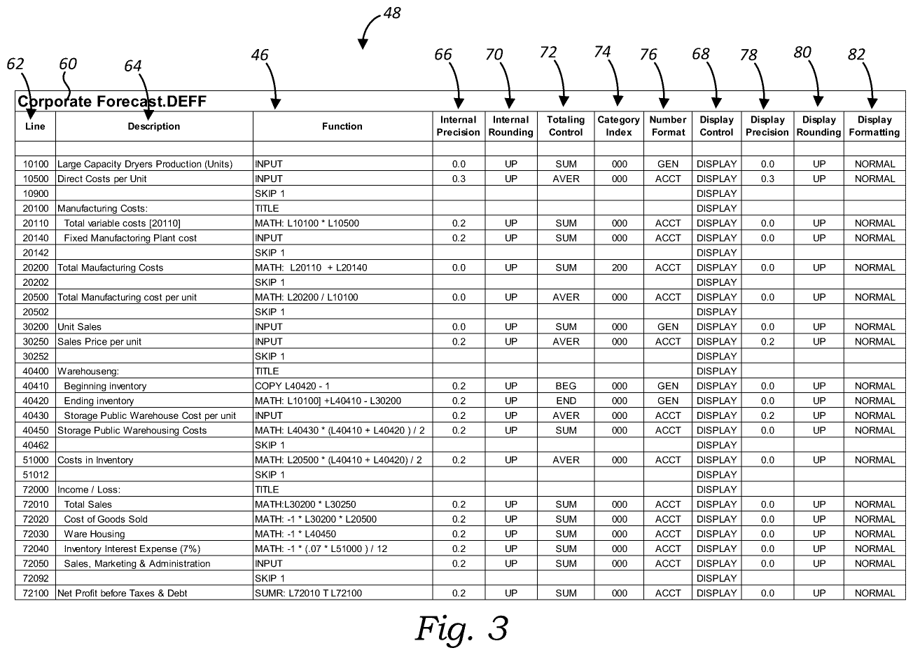

In at least one embodiment, as illustrated in FIG. 3, a definition file 48 contains select details related to the structure of the corresponding spreadsheet 22, along with the row logic 46 for each cell 24 in the spreadsheet 22. In at least one embodiment, the definition file 48 is stored on the computing device 30 or data storage device 32 as a file with a “.DEFF” extension. However, in further embodiments, the definition file 48 may be stored as any other type of data structure, now known or later developed, and using any other naming convention.

In at least one embodiment, a model file contains a compiled version of the definition file 48 for the corresponding spreadsheet 22, after the computing device 30 has checked the definition file 48 for proper syntax and line references, as discussed further below. In at least one embodiment, the model file is stored on the computing device 30 or data storage device 32 as a file with a “.MODF” extension. However, in further embodiments, the model file may be stored as any other type of data structure, now known or later developed, and using any other naming convention.

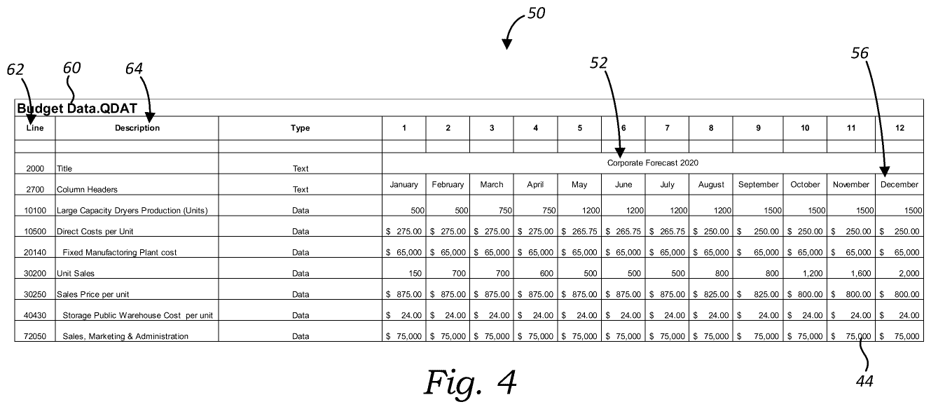

In at least one embodiment, as illustrated in FIG. 4, a data query file 50 contains select details related to the overall parameters of the corresponding spreadsheet 22, including one or more of a spreadsheet title 52, spreadsheet time periods 54, column headings 56, the cell data 44 for each cell 24 in the spreadsheet 22, and an at least one data source for the cell data 44. In at least one embodiment, the at least one data source is data that is manually entered by the user via a keyboard in communication with the computing device 30. In at least one further embodiment, the at least one data source may also include data that is pulled by the user application 36 from external sources—e.g., other spreadsheets 22, formal database queries, etc. In at least one such embodiment, the at least one data source may be stored on the at least one spreadsheet database 34. In at least one embodiment, the details contained in the data query file 50 are collectively referred to herein as the “prolog.” In at least one embodiment, the data query file 50 is stored on the computing device 30 or data storage device 32 as a file with a “.QDAT” extension. However, in further embodiments, the data query file 50 may be stored as any other type of data structure, now known or later developed, and using any other naming convention.

In at least one embodiment, a data file contains a compiled version of the data query file 50 for the corresponding spreadsheet 22, after the computing device 30 has checked the validity of the data sources and the parameters for querying the data sources, as discussed further below. In at least one embodiment, the data file is stored on the computing device 30 or data storage device 32 as a file with a “.DATA” extension. However, in further embodiments, the data file may be stored as any other type of data structure, now known or later developed, and using any other naming convention.

In at least one embodiment, as illustrated in FIG. 2, a rendered report file 58 contains merged data from each of the model file and data file of the corresponding spreadsheet 22, as discussed further below. In other words, the rendered report file 58 is the financial spreadsheet 22. In at least one embodiment, the rendered report file 58 is stored on the computing device 30 or data storage device 32 as a file with a “.RRPT” extension. However, in further embodiments, the rendered report file 58 may be stored as any other type of data structure, now known or later developed, and using any other naming convention.

In at least one embodiment, a genesis file contains an initial and primary rendered report file 58 of the corresponding spreadsheet 22, as discussed further below. In at least one embodiment, the genesis file is stored on the computing device 30 or data storage device 32 as a file with a “.RRPT” extension. However, in further embodiments, the definition file 48 may be stored as any other type of data structure, now known or later developed, and using any other naming convention.

It should be noted that while each of the above discussed spreadsheet data files are described as separate data files, in at least one further embodiment, one or more of the above discussed spreadsheet data files may be contained in a single data file.

In at least one embodiment, each of the model file, data file and rendered report file 58 of the corresponding spreadsheet 22 is configured for containing up to 100,000 lines total. In at least one such embodiment, a first line (i.e., line 0) of each of the model file, data file and rendered report file 58 is configured for storing a unique file identifier 60, and lines 1000 through 9999 are reserved for the prolog. In the model file, the remaining lines 10000 through 99999 contain the rows 26 (hereinafter referred to as “input rows 26”), row logic 46 and any associated formatting instructions for the cell data 44; in the data file, the remaining lines 10000 through 99999 contain the cell data 44, projections and secondary references;

and in the rendered report file 58, the remaining lines 10000 through 99999 contain the merged contents of lines 10000 through 99999 from both the model file and data file. In further embodiments, each of the model file, data file and rendered report file 58 may be configured for containing more than 100,000 lines total, with those lines being apportioned proportionally as described above.

In at least one embodiment, the file identifier 60 contains a value that indicates the type of spreadsheet data file. Non-limiting examples of possible file identifiers 60 are as follows:
Line 0:
   DEFF—Model Definition file (model formulas and logic)
   MODF—Compiled Model Logic and Formulas File
   QDAT—Data query file
   DATA—Data File
   RRPT—Rendered Report
   RWIF—What-If Report
   RGSK—Goal Seeking Report
   RPAN—Pancake Consolidation Report
   RSTG—Staggered Consolidation Report
   RSEN—Sensitivity Analysis Report
   RBRA—Baseline Ratio Analysis Report
   RBPA—Baseline Period Analysis Report
   RPPA—Period-to-Period Analysis Report

In at least one embodiment, non-limiting examples of prolog data for lines 1000 through 9999 are as follows:
Line 1200—Number of Spreadsheet Columns
Line 1400—Spreadsheet Start Date
Line 1500—Column Time period type (Example: 1500 M).
   (Example: 1500 M,M,M,M,M,M,M,M,M,M,M,M,Y,Y,Y)
   Y—Year
   Q—Quarter (3 months)
   M—Month
   W—Week (7 Days)
   D—Day
   H—Hour
   C—Custom
Lines 2000-2199 Spreadsheet title
   2010 Left
   2020 Center
   2030 Right
Lines 2200-2399 Spreadsheet Footer
   2210 Left
   2220 Center
   2230 Right
Line 2600—Column Titles

As mentioned above, in at least one embodiment, the definition file 48 contains select details related to the structure of the corresponding spreadsheet 22, along with the row logic 46 for each row 26 in the spreadsheet 22. The definition file 48 also determines how cell data 44 from the corresponding data file is to be manipulated and considered within the corresponding spreadsheet 22. In at least one embodiment, the user application 36 provides a model editor tool that assists users with creating and inputting the structure and row logic 46 for the corresponding spreadsheet 22 into lines 10000 through 99999 of the definition file 48. In at least one embodiment, all references must be to preceding lines in the definition file 48. Forward referencing (i.e., a line in the definition file 48 that references a subsequent line) is permitted only with a few operations such as those that initiate a processing loop or which control conditional execution of groups of lines. Where more than one line is included in an instruction, the reference may be to the same line if this will produce the desired calculation. In at least one embodiment, line references in the definition file 48 are always preceded with the letter “L” (e.g., “L25101,” which refers to line number 25101 within the definition file 48), while column 28 references are preceded with the letter “C” (e.g., “C3” for the third column 28 from the left, “CBEG” for the first column 28, and “CEND” for the last column 28), and a numeric constant does not require a letter designation (e.g., “5” is 5). In at least one embodiment, constants may be either positive or negative and may be of any value. When an operation includes factored values from a line, the user may enter a factor of 1 if they do not wish to alter the line values. In at least one embodiment, the various operations provide a wide variety of computations, along with a free-form algebraic statement and an extensive logical comparison of up to four pairs of entries. By employing one or more of the operations, it should be possible to obtain any desired calculation. If calculation results in division by or into zero, the result will be zero; no special indicator is printed. In the case where a formula tries to divide by “0”, the user application 36 will throw 26 an error message prompting the user to cancel the operation or to proceed. If the user chooses to proceed, the user application 36 will enter a “0” in that location, then it will ask if the user would prefer not to have that question asked again. The user application 36 will have the option to address these issues in the universal properties at the time the user creates the definition file 48.

FIG. 3 illustrates an exemplary definition file 48 in at least one embodiment. In at least one embodiment, each line of the definition file 48 contains three required data points, while the other data points in each line will generally have defaults which can be changed (except where they do not apply, depending on the operation type). The three required data points are a line number 62 (shown as the first column 28 of the definition file 48), a line description 64 (shown as the second column 28 of the definition file 48), and a row logic 46 (shown as the third column 28 of the definition file 48). In at least one embodiment, the line number 62 value is an integer that is unique to the corresponding spreadsheet 22 and ranges from 10000 to 99999; however, in further embodiments, the line number 62 value may have any other range. The line number 62 is an absolute reference for the corresponding row 26 in the spreadsheet 22, and also establishes the order in which the corresponding row logic 46 for each line is processed. In at least one embodiment, the line number 62 values for successive lines in the definition file 48 are sequential; however, in at least one embodiment, there may be gaps in the sequence of line number 62 values, to allow for the subsequent insertion of additional lines in future modifications to the definition file 48.

In at least one embodiment, the line description 64 is a short description for the corresponding line—such as what type of value the line contains, or a description of the row logic 46 being performed on the line, for example—to assist the user in identifying and describing the line when subsequently auditing the spreadsheet 22. In at least one embodiment, the row logic 46 contains the function that the corresponding line is to perform. Non-limiting examples of functions that could be performed include mathematical calculations on one or more lines, logic (e.g., logical controls, loops, go-to's, etc.), input data, formatting (e.g., skip lines, underline, etc.), and text (e.g., comments, titles, etc.).

In at least one embodiment, beyond the above-discussed three required data points, each line of the definition file 48 may also include one or more additional line instructions or properties. In at least one embodiment, one such additional line property is an internal precision property 66, which dictates how many decimal places the calculated result will have internally. Numbers stored internally in the rendered report file 58 may be different from the printed numbers which are rounded for display or printing in accordance with a display control property 68 (discussed below). It is often considered important that the numbers stored internally retain greater accuracy than the rounded numbers appearing on the printed output. This will ensure the greatest degree of accuracy possible when the numbers are used in subsequent calculations. In at least one embodiment, another additional line property is an internal rounding property 70, which dictates whether and how to round internally stored numbers to conform with the printed numbers so that all totals will foot and cross-foot. In at least one embodiment, another additional line property is a totaling control property 72, which dictates how each totaling column 28 is to be handled. Non-limiting examples include summing all numbers from last total (e.g., total yearly sales from a monthly report), recalculating the total based on the current total columns 28 (e.g., marketing expenses as a percentage of sales), average (e.g., calculating an average total of the columns 28 from the last total column 28), etc. In at least one embodiment, another additional line property is a category index property 74, which provides multiple ways to sum or select rows 26 within a range without having to manually select each row 26 needed and provides additional views of data without additional coding. In at least one embodiment, a category index, ranging from 001 to 999, may be indicated for any data input or calculation line to permit “selective summation” within a range of lines. When a summation operation with a declared category index (other than 000, which is the default notation) is used to sum a range of lines, only those lines having the same category index within the specified range will be included in the summation. In at least one embodiment, if the category index is 000 or no category index is specified, all lines are included in the summation. In at least one embodiment, another additional line property is a number format property 76, which dictates any special formatting for the cell data 44 (e.g., currency, alphanumeric, percentages, negative values, etc.). In at least one embodiment, another additional line property is a display control property 68, which dictates whether and when to display the corresponding line of the spreadsheet 22 to the user in different modes (i.e., report mode, auditing mode, etc.). Some lines in a spreadsheet 22 may contain interim calculations which are not desirable to show on a final report. There may also be report formatting lines that are intended to print only if the interim calculations are to be displayed. These lines can be included in an audit report, but are not normally printed. There may be instances where the spreadsheet 22 may not want to display portions of the calculations, except when auditing or reviewing the spreadsheet 22's logic. Furthermore, some lines should appear only if they have been “data activated” by the presence of a non-zero value in at least one column 28 of the line; otherwise they should be suppressed from printing. In at least one embodiment, another additional line property is a display rounding property 78, which dictates whether and how to round numbers as they are to be displayed/printed. In at least one embodiment, another additional line property is a display scaling property 80, which allows the user to display numbers in more manageable figures which are easier to read and assimilate. Typically, when dealing with figures in the millions, tens of millions and hundreds of millions and more, it can be easier to read and assimilate those figures by dividing them by 1000, or 1,000,000 thereby, for example, making a figure of $1,353,470 be represented as $1,353.5 or $1.4, respectively (assuming the user chooses to depict a 1-decimal place rounding). In at least one embodiment, the display scaling property 80 is represented by a number of “0”s, commensurate with whether the user wishes to scale by 10, 100, 1,000, etc. up to 1,000,000, which is to be the base of the scaling, rounding the numbers to the corresponding digit left of the decimal place. In at least one embodiment, another additional line property is a display formatting property 82, which allows the user to select the formatting for the corresponding line (e.g., bold, italicized, underlined, font, font color, font size, horizontal alignment, etc.). In at least one embodiment, another additional line property is a note field, which allows the user to enter any additional notes or comments which may be helpful for understanding the corresponding line.

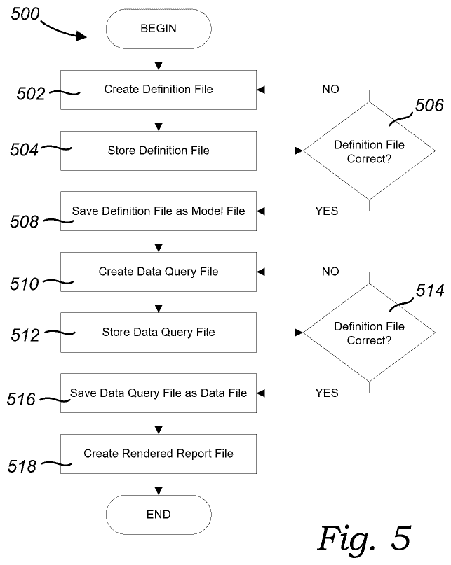

In at least one embodiment, the system 20 is capable of securely creating and managing the at least one spreadsheet 22 by virtue of keeping the corresponding cell data 44 and row logic 46 in separate editable files—specifically, the definition file 48 for the row logic 46 (which ultimately becomes the locked, read-only model file) and the data query file 50 for the cell data 44 (which ultimately becomes the locked, read-only data file). In at least one embodiment, as illustrated in the flow diagram of FIG. 5, through the user application 36 residing either locally in memory 38 on the computing device 30 or remotely on the server 40, the method of securely creating and managing the at least one financial spreadsheet 22 entails the steps of the user creating the definition file 48 and populating the definition file 48 with at least the line number 62, line description 64 and row logic 46 for each row 26 in the spreadsheet 22 to be created (502), such that each row 26 in the definition file 48 corresponds to a row 26 in the spreadsheet 22 to be created. In at least one embodiment, the user may further specify one or more of the internal precision property 66, the internal rounding property 70, the totaling control property 72, the category index property 74, the number format property 76, the display control property 68, the display rounding property 78, the display scaling property 80, the display formatting property 82, and the note field for each row 26 in the spreadsheet 22 to be created. In at least one embodiment, the created definition file 48 is then stored on the computing device 30 or data storage device 32 (504). In at least one embodiment, the user application 36 checks the definition file 48 to confirm that the line number 62, line description 64 and row logic 46 contained in each row 26 of the definition file 48 uses proper syntax and line references (506); and if so, the user application 36 saves the definition file 48 as a corresponding read-only model file, which is not editable by the user (508).

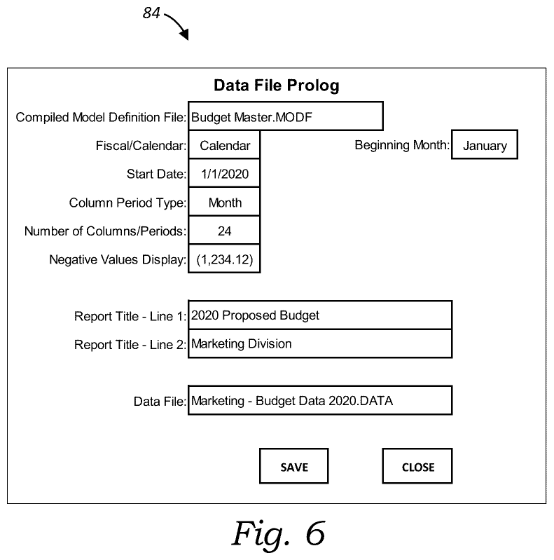

In at least one embodiment, the user next creates the data query file 50 for the spreadsheet 22 to be created, based on the parameters from the corresponding model file, and populates the data query file 50 with one or more of the spreadsheet title 52 for the spreadsheet 22 to be created, the spreadsheet time period 54 for the spreadsheet 22 to be created (i.e., the time period to which the cell data 44 of the spreadsheet 22 relates), a column heading 56 for each column 28 of the spreadsheet 22 to be created, and cell data 44 for each row 26 in the spreadsheet 22 to be created (510), such that each row 26 of the data query file 50 corresponds to a row 26 of the definition file 48, with said corresponding rows 26 of the data query file 50 and definition file 48 sharing the same line number 62. In at least one embodiment, rather than the user manually inputting the cell data 44 for each row 26 in the spreadsheet 22 to be created, the user may instead identify at least one data source from which the cell data 44 for each row 26 may be automatically accessed and obtained by the user application 36. In other words, each line of the data query file 50 can be structured for direct keyboard input, or to seek other data sources which are handled as a static snapshot of the database being queried at that moment. Thus, a line in the data query file 50 can be an instruction to make a SQL query, query other databases, access an external spreadsheet 22, or gather data from another spreadsheet 22. In at least one embodiment, the data query file 50 is the editable version of the read-only data file, and allows the user to make changes to both the data queries (entries from the keyboard, or to the data queries from external sources), as well as a data query prolog module 84, which is an integral part of the data query file 50. As illustrated in FIG. 6, the data query prolog module 84 contains some of the basic information to establish parameters for the data to be used. For instance, the prolog will set the fiscal period, whether it is a calendar year, or a fiscal year, and the start date, type of fiscal period (years, months, weeks, etc.), number of periods in the spreadsheet 22, as well as showing the report titles to be used, column headings 56, the treatment of displaying negatives in the report, and the genesis file from which the data file is derived. In at least one embodiment, the key information from the data query prolog module 84 is displayed at the top of the data query file 50 editor to allow the user a quick reference to the main parameters set for the particular data query file 50. In at least one embodiment, the created data query file 50 is then stored on the computing device 30 or data storage device 32 (512). In at least one embodiment, the user application 36 checks the data query file 50 to confirm that the cell data 44 is valid (514); and if so, the user application 36 saves the data query file 50 as a corresponding read-only data file, which is not editable by the user (516).

In at least one embodiment, once the data query file 50 is compiled into the data file the data file is no longer editable, and no longer contains the query instructions. Thus, the data file merely contains the cell data 44 to be used with whatever model file (i.e., row logic 46) the user chooses to combine it with in order to create a desired rendered report file 58, as discussed further below. In at least one embodiment, the rendered report file 58 contains the data from the sources but no longer contains the instructions of how to get that data. In order to produce a rendered report file 58, the model file has to be combined with the data file. The compiled model file contains the lead instructions for accessing the compiled data file. The data file provides the actual values to be processed. Each line in the rendered report file 58 is processed sequentially. The data query file's 50 prolog information (a special area of the data query file 50, in which the parameters of the data to be used are set) is also transferred to the rendered report file 58. In at least one embodiment, the data file may contain more line number 62s than the translated definition file 48, and the model file may contain more input lines than lines of data contained within the data file. This allows for different data sets to be applied against the same definition file 48.

Referring again to FIG. 5, in at least one embodiment, the user application 36 combines the model file and data file in order to create the rendered report file 58, which is also the spreadsheet 22 (518). The resulting rendered report file 58 is also referred to as the genesis file. In at least one embodiment, the rendered report file 58 contains the line numbers 62 and line descriptions 64 from the model file, and further contains the spreadsheet title 52, spreadsheet time period 54, column headings 56 and cell data 44 from the data file, with the rendered report file 58 being formatted based on the details contained in the model file, and the cell data 44 for each row 26 being modified based on the corresponding row logic 46 from the model file. In at least one embodiment, the computing device 30 accesses the model file, reads each line in the model file, and only displays the lines containing an “Input” operation code or “Title” operation code that includes a display for input parameter. For each such line in the model file, the computing device 30 also displays select details contained in the line. In at least one embodiment, the data file creation interface is designed to make access to crucial parts and functions of the user application 36 convenient and intuitive. For example, the user is able to create a new data file, edit an existing data file, save a data file, and compile a data query file 50 into a data file. The user application 36 also allows the user to merge a model file and a data file in order to produce a desired rendered report file 58. In at least one embodiment, the data query prolog module 84 defines the structure of the time periods represented in the columns 28, provides the title for the spreadsheet 22, and other parameters of the spreadsheet 22.

In at least one embodiment, the rendered report file 58 contains the row logic 46 and cell data 44 in a secure format, preventing either component from being tampered with or changed inadvertently. Therefore, it may be reprocessed time and again through various scenarios such as what-if, goal-seeking, consolidation, analytical reports, etc. In each of those scenarios, the resulting new report is saved as a different file. As such, the original rendered report file 58 is read-only and cannot be edited—only saved as a new type of report file. In at least one embodiment, in order to change the row logic 46 for the corresponding spreadsheet 22, the user must edit the original model file and then re-compile it. This provides the security and auditability ensuring the integrity of the system 20 and the corresponding spreadsheet 22 overall.

The task of finding an error in known prior art spreadsheet 22 solutions can become daunting, to say the least. As discussed above, most known prior art spreadsheet 22 solutions depend on a matrix layout where each cell 24 contains either a value or a formula forcing all calculations and instructions to be carried out on a cell-by-cell basis. A typical 500-row 26 spreadsheet 22 (very modest by most corporate standards) with only yearly totals will result in 13,000 cells 24, each of which has the potential for an error; and some multi-year financial spreadsheets 22 could have 5,000 rows 26 or more. Proper corporate compliance regulations and risk management protocols require that each of those 13,000 cells 24 in a 500-row 26 spreadsheet 22 must be checked to ensure the integrity of the corporation's public reporting; and with row logic 46 often including long and complex formulas, along with cell 24 references that can be difficult to trace, the task of checking the integrity of every single cell 24 in a spreadsheet 22 using a known prior art spreadsheet 22 solution can be extremely time-consuming, costly, and arduous, if not nearly impossible. By comparison, the methods for securely creating and managing an at least one financial spreadsheet 22 by the system 20, as discussed herein, is based on a row-by-row approach where each cell 24 in a given row 26 carries the same row logic 46. It is immediately evident that this reduces exponentially the opportunities for errors, as the integrity of the spreadsheet 22 can be performed on a row-by-row basis rather than an individual cell-by-cell basis. Furthermore, with the row 26 descriptions and line number 62 references that are included in the spreadsheet 22, integrity checks become even easier. Thus, the system 20 is configured to not only reduce the likelihood of mistakes, but to also make it easier for the user to find them, should they, despite all precautions, have slipped into the spreadsheet 22 (either the cell data 44 or the row logic 46). While the elimination of errors is a crucial feature to have, the need to understand the logic and structure of a spreadsheet 22, particularly for someone who may not be familiar with it but has a stakeholder interest, is equally important. This makes it truly simple for someone to step in and continue work with a spreadsheet 22 created with the system 20 by clearly and quickly understanding the logic of a spreadsheet 22 that was previously created by someone else.

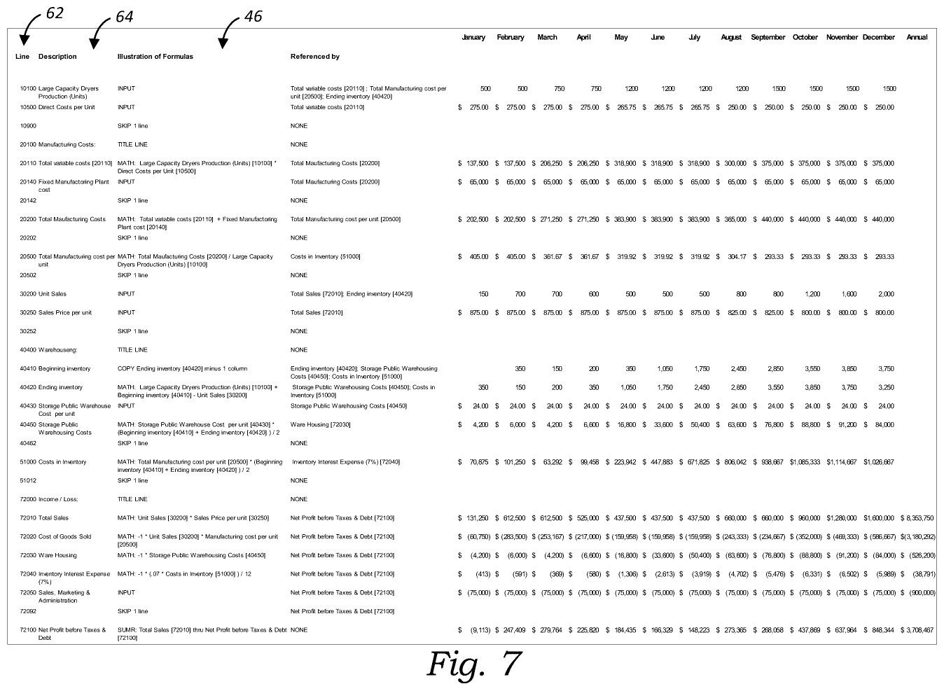

In at least one embodiment, as illustrated in FIG. 7, the user is able to audit the spreadsheet 22 using the line descriptions 64 and row logic 46 for each row 26 as contained in the corresponding definition file 48, which describes the row logic 46 in clear, easy to understand language. Thus, there is no need for the user to trace precedents of a given cell 24 (cells 24 which affect a given cell 24 by it drawing upon the information in those cells 24) or dependents of a given cell 24 (cells 24 which may be affected by a given cell 24) only to then further have to scan across to the spreadsheet's 22 description line to make sure the proper cell 24 is being analyzed and that the user is drawing upon the proper information. In at least one embodiment, this audit feature of the system 20 displays each row 26, describing the function for that line (be it a simple title, data, logical instruction, or a formula for calculation) as well as the line references. In this manner, the user can see any dependent lines within the spreadsheet 22 (lines which may be affected by a given line) or any precedent lines within the spreadsheet 22 (lines which affect a given line by it drawing upon the information in those lines). All of this is depicted for each line, and even more importantly, the user can see this for the whole spreadsheet 22 at a glance. The ability to easily trace the model logic allows the user to quickly determine whether there are any flaws in the structure, and whether the references and/or cell data 44 are correct, thus ensuring the integrity of the spreadsheet 22. Thus, the system 20 allows for the checking of each line/row 26 in the spreadsheet 22 rather than each individual cell 24 in the spreadsheet 22. The ability to cross-reference rows 26 in a given spreadsheet 22 is another useful feature of the system 20, in at least one embodiment, which will show the user specifically which lines/rows 26 are being called or referenced in both line number 62 and their titles, so the user can quickly determine whether the associated row logic 46 is even set up correctly to begin with. There is no need to go scrolling through a long spreadsheet 22 to find and check the line—it is shown and described in clear, easy to understand language.

Another value of the system 20 becomes apparent once the user learns to use the various analytical tools and reports provided by the system 20. Once the genesis file of the rendered report file 58 is created, the genesis file becomes the basis for all further manipulations and analysis of the given data set. In at least one embodiment, one such analytical report is a what-if report, which allows for the creation of various scenarios from an existing rendered report file 58. In order to maintain the integrity of the spreadsheet 22 and its row logic 46, only those lines designated as data input lines can be modified. Except for the number of periods (columns 28) the model prolog may also be modified. This is especially significant if the user wishes to change the start date for the spreadsheet 22. In at least one embodiment, the what-if report is stored on the computing device 30 or data storage device 32 as a file with a “.RWIF” extension. However, in further embodiments, the what-if report may be stored as any other type of data structure, now known or later developed, and using any other naming convention.

In at least one embodiment, another analytical report is a goal seeking report, which allows the user to determine the results being sought, and then determine which parameters of the spreadsheet 22 are to be changed in order to achieve the desired results. This analysis is trickier as it depends heavily on a well-though-through spreadsheet 22 with sufficient data points that can be considered by the user application 36 when presenting options in order to reach a desired result. Ultimately, the more complex the underlying spreadsheet 22 is, the more effective the goal seeking report will be. The goal seeking report will consider the goals entered by the user and will then determine the factors that go into achieving the results (the entered goals). It will then be up to the user to decide which of the factors to change in order to achieve a desired “goal.” In at least one embodiment, the goal seeking report is stored on the computing device 30 or data storage device 32 as a file with a “.RGSK” extension. However, in further embodiments, the goal seeking report may be stored as any other type of data structure, now known or later developed, and using any other naming convention.

In at least one embodiment, another analytical report is a consolidation report, which allows the user to take two or more reports and add the results of each in the chosen area into a final consolidated report. This does not mean that the methods of reaching the consolidated results are adjusted for each (the calculations and criteria that go into them), but rather only the results of each range of lines that is to be consolidated. Typically, a company will have similar spreadsheets 22 for each division and the spreadsheets 22 will all be set up to have the identical line numbers 62 for similar costs and revenues. The concept of consolidation takes the identical line numbers 62 from different divisions (rendered report files 58) and add them into a consolidation report which will then show the overall result for the company in general. In at least one embodiment, the consolidation report is stored on the computing device 30 or data storage device 32 as a file with a “.RPAN” or “.RSTG” extension. However, in further embodiments, the consolidation report may be stored as any other type of data structure, now known or later developed, and using any other naming convention.

In at least one embodiment, another analytical report is a sensitivity analysis report, which shows the actual or percentage difference between two existing rendered report files 58. This is useful for showing item by item (cell 24 by cell 24), the differences between two spreadsheet 22 reports, a budget report, an actuals report, etc. This is also very helpful when generating a what-if report or goal seeking report, since it allows the user to compare in detail the differences between the original and the recalculated reports. In at least one embodiment, the sensitivity analysis report is stored on the computing device 30 or data storage device 32 as a file with a “.RSEN” extension. However, in further embodiments, the sensitivity analysis report may be stored as any other type of data structure, now known or later developed, and using any other naming convention.

In at least one embodiment, another analytical report is a baseline ratio analysis report, which allows the user to present various line items in the rendered report file 58 as ratios of another base line in the report. Ratios are printed with three decimal places; alternatively, the ratios may be presented as percentages with two decimal places. The baseline is the line against which the other lines will be measured. It is the dividend and into the lines being compared. The user may have multiple baselines with each baseline having its corresponding range of lines. If division by zero occurs the value will be shown as zero. In at least one embodiment, the baseline ratio report is stored on the computing device 30 or data storage device 32 as a file with a “.RBRA” extension. However, in further embodiments, the baseline ratio report may be stored as any other type of data structure, now known or later developed, and using any other naming convention.

In at least one embodiment, another analytical report is a baseline period analysis report, which allows the user to present the columns 28 of a rendered report file 58 as ratios of a specific base column 28. The base column 28 valuables will be shown as 1.000 and the other column 28 values will be calculated as ratios of the base column 28 printed with three decimal places. In at least one embodiment, the baseline period report is stored on the computing device 30 or data storage device 32 as a file with a “.RBPA” extension. However, in further embodiments, the baseline period report may be stored as any other type of data structure, now known or later developed, and using any other naming convention.

In at least one embodiment, another analytical report is a period-to-period analysis report, which allows the user to print a report file that copies the first column 28 of an existing rendered report file 58, and then shows the remaining columns 28 as either that percentage or an actual change from the immediately preceding column 28. Percentages are shown with two decimal places; if the change is negative, it is shown with a minus sign. The format of the report is identical to that of the report on which it is based. If division by or in zero occurs in the calculation, the column 28 value will be shown as zero. In at least one embodiment, the period-to-period analysis report is stored on the computing device 30 or data storage device 32 as a file with a “.RPPA” extension. However, in further embodiments, the period-to-period analysis report may be stored as any other type of data structure, now known or later developed, and using any other naming convention.

Accordingly, the system 20 is capable of keeping spreadsheet 22 data separate from spreadsheet 22 formulas and functions to be performed on that data, so as to minimize overwriting and errors, simplify the export of logic to other spreadsheets 22, and better prevent tampering and data falsification; thus, creating a safer, more standardized financial modeling software that will not only save companies billions of dollars and make analysts' jobs easier, but will also aid regulators in preventing fraud.

Aspects of the present specification may also be described as the following embodiments:
1. A method for securely creating and managing an at least one financial spreadsheet containing a plurality of cells arranged as a plurality of rows and columns, with each cell containing cell data, the method comprising the steps of: implementing a user application residing in memory on an at least one computing device, the at least one computing device configured for receiving and processing select data related to the at least one financial spreadsheet; and for each of the at least one financial spreadsheet: the user application creating a definition file containing a plurality of lines, with each line corresponding to a row of the financial spreadsheet and containing a line number, a line description, and a row logic to be applied to each cell in the corresponding row of the financial spreadsheet; the user application storing the definition file; the user application validating the definition file to confirm that the line number, line description and row logic contained in each line of the definition file uses proper syntax and line references; upon the user application determining that the line number, line description and row logic contained in each line of the definition file uses proper syntax and line references, the user application saving the definition file as a read-only model file; the user application creating a data query file containing a plurality of lines, with each line corresponding to a row of the financial spreadsheet and containing a line number and cell data for each cell in the corresponding row of the financial spreadsheet, such that a given line of each of the data query file and definition file corresponding to the same row of the financial spreadsheet shares the same line number; the user application populating the cell data in the data query file; the user application storing the data query file; the user application validating the data query file to confirm that the cell data contained in each line of the data query file is valid; upon the user application determining that the cell data contained in each line of the data query file is valid, the user application saving the data query file as a read-only data file; and the user application combining the model file and the data file to create a rendered report file containing a plurality of cells arranged as a plurality of rows and columns, with each row of the rendered report file containing the line number and line description from the corresponding line of the model file, each cell within a given row of the rendered report file containing the cell data from the corresponding line of the data file, and the cell data of each cell within a given row of the rendered report file being modified based on the row logic from the corresponding line of the model file.
2. The method according to embodiment 1, wherein the step of the user application creating a definition file further comprises the step of the user application adding one or more of an internal precision property, an internal rounding property, a totaling control property, a category index property, a number format property, a display control property, a display rounding property, a display scaling property, a display formatting property, and a note field to each line of the definition file.
3. The method according to embodiments 1-2, wherein the step of the user application populating the cell data in the data query file further comprises the step of the user application allowing a user to manually input the cell data.
4. The method according to embodiments 1-3, wherein the step of the user application populating the cell data in the data query file further comprises the step of the user application automatically accessing and obtaining the cell data from an at least one data source in selective communication with the at least one computing device.
5. The method according to embodiments 1-4, further comprising the steps of: the user application adding to the data query file a data query prolog containing at least one of a spreadsheet title, a spreadsheet time period, and a column heading for each column of the financial spreadsheet; and the user application adding to the rendered report file the spreadsheet title, spreadsheet time period and column headings from the data query prolog of the data file.
6. The method according to embodiments 1-5, wherein the step of the user application combining the model file and the data file to create a rendered report file further comprises the step of the user application only displaying lines from the model file containing an operation code that indicates the corresponding line is intended to be displayed.
7. The method according to embodiments 1-6, further comprising the step of implementing an at least one data storage device in selective communication with the computing device and configured for storing select data related to the at least one financial spreadsheet.
8. A financial spreadsheet modeling system for securely creating and managing an at least one financial spreadsheet containing a plurality of cells arranged as a plurality of rows and columns, with each cell containing cell data, the system comprising: a computing device configured for receiving and processing select data related to the at least one financial spreadsheet, the computing device containing a user application residing in memory on the computing device and configured for, for each of the at least one financial spreadsheet: creating a definition file containing a plurality of lines, with each line corresponding to a row of the financial spreadsheet and containing a line number, a line description, and a row logic to be applied to each cell in the corresponding row of the financial spreadsheet; storing the definition file; validating the definition file to confirm that the line number, line description and row logic contained in each line of the definition file uses proper syntax and line references; upon determining that the line number, line description and row logic contained in each line of the definition file uses proper syntax and line references, saving the definition file as a read-only model file; creating a data query file containing a plurality of lines, with each line corresponding to a row of the financial spreadsheet and containing a line number and cell data for each cell in the corresponding row of the financial spreadsheet, such that a given line of each of the data query file and definition file corresponding to the same row of the financial spreadsheet shares the same line number; populating the cell data in the data query file; storing the data query file; validating the data query file to confirm that the cell data contained in each line of the data query file is valid; upon determining that the cell data contained in each line of the data query file is valid, saving the data query file as a read-only data file; and combining the model file and the data file to create a rendered report file containing a plurality of cells arranged as a plurality of rows and columns, with each row of the rendered report file containing the line number and line description from the corresponding line of the model file, each cell within a given row of the rendered report file containing the cell data from the corresponding line of the data file, and the cell data of each cell within a given row of the rendered report file being modified based on the row logic from the corresponding line of the model file.
9. The financial spreadsheet modeling system according to embodiment 8, further comprising an at least one data storage device in selective communication with the computing device and configured for storing select data related to the at least one financial spreadsheet.
10. The financial spreadsheet modeling system according to embodiments 8-9, wherein, while creating a definition file, the user application is further configured for adding one or more of an internal precision property, an internal rounding property, a totaling control property, a category index property, a number format property, a display control property, a display rounding property, a display scaling property, a display formatting property, and a note field to each line of the definition file.
11. The financial spreadsheet modeling system according to embodiments 8-10, wherein, while populating the cell data in the data query file, the user application is further configured for allowing a user to manually input the cell data.
12. The financial spreadsheet modeling system according to embodiments 8-11, wherein, while populating the cell data in the data query file, the user application is further configured for automatically accessing and obtaining the cell data from an at least one data source in selective communication with the at least one computing device.
13. The financial spreadsheet modeling system according to embodiments 8-12, wherein the user application is further configured for: adding to the data query file a data query prolog containing at least one of a spreadsheet title, a spreadsheet time period, and a column heading for each column of the financial spreadsheet; and adding to the rendered report file the spreadsheet title, spreadsheet time period and column headings from the data query prolog of the data file.
14. The financial spreadsheet modeling system according to embodiments 8-13, wherein, while combining the model file and the data file to create a rendered report file, the user application is further configured for only displaying lines from the model file containing an operation code that indicates the corresponding line is intended to be displayed.
15. A non-transitory computer readable medium containing program instructions for causing an at least one computing device to perform a method of securely creating and managing an at least one financial spreadsheet containing a plurality of cells arranged as a plurality of rows and columns, with each cell containing cell data, the method comprising the steps of, for each of the at least one financial spreadsheet: creating a definition file containing a plurality of lines, with each line corresponding to a row of the financial spreadsheet and containing a line number, a line description, and a row logic to be applied to each cell in the corresponding row of the financial spreadsheet; storing the definition file; validating the definition file to confirm that the line number, line description and row logic contained in each line of the definition file uses proper syntax and line references; upon determining that the line number, line description and row logic contained in each line of the definition file uses proper syntax and line references, saving the definition file as a read-only model file; creating a data query file containing a plurality of lines, with each line corresponding to a row of the financial spreadsheet and containing a line number and cell data for each cell in the corresponding row of the financial spreadsheet, such that a given line of each of the data query file and definition file corresponding to the same row of the financial spreadsheet shares the same line number; populating the cell data in the data query file; storing the data query file; validating the data query file to confirm that the cell data contained in each line of the data query file is valid; upon determining that the cell data contained in each line of the data query file is valid, saving the data query file as a read-only data file; and combining the model file and the data file to create a rendered report file containing a plurality of cells arranged as a plurality of rows and columns, with each row of the rendered report file containing the line number and line description from the corresponding line of the model file, each cell within a given row of the rendered report file containing the cell data from the corresponding line of the data file, and the cell data of each cell within a given row of the rendered report file being modified based on the row logic from the corresponding line of the model file.
16. The method according to embodiment 15, wherein the step of creating a definition file further comprises the step of adding one or more of an internal precision property, an internal rounding property, a totaling control property, a category index property, a number format property, a display control property, a display rounding property, a display scaling property, a display formatting property, and a note field to each line of the definition file.
17. The method according to embodiments 15-16, wherein the step of populating the cell data in the data query file further comprises the step of allowing a user to manually input the cell data.
18. The method according to embodiments 15-17, wherein the step of populating the cell data in the data query file further comprises the step of automatically accessing and obtaining the cell data from an at least one data source in selective communication with the at least one computing device.
19. The method according to embodiments 15-18, further comprising the steps of: adding to the data query file a data query prolog containing at least one of a spreadsheet title, a spreadsheet time period, and a column heading for each column of the financial spreadsheet; and adding to the rendered report file the spreadsheet title, spreadsheet time period and column headings from the data query prolog of the data file.
20. The method according to embodiments 15-19, wherein the step of combining the model file and the data file to create a rendered report file further comprises the step of only displaying lines from the model file containing an operation code that indicates the corresponding line is intended to be displayed.

In closing, regarding the exemplary embodiments of the present invention as shown and described herein, it will be appreciated that a financial spreadsheet modeling system is disclosed and configured for securely creating and managing an at least one financial spreadsheet. Because the principles of the invention may be practiced in a number of configurations beyond those shown and described, it is to be understood that the invention is not in any way limited by the exemplary embodiments, but is generally directed to a financial spreadsheet modeling system and is able to take numerous forms to do so without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the terms “about” and “approximately.” As used herein, the terms “about” and “approximately” mean that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art, or at least encompassing a range of plus or minus ten percent above and below the value of the stated characteristic, item, quantity, parameter, property, or term.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

Any claims intended to be treated under 35 U.S.C. § 112(f) will begin with the words “means for,” but use of the term “for” in any other context is not intended to invoke treatment under 35 U.S.C. § 112(f). Accordingly, Applicant reserves the right to pursue additional claims after filing this application, in either this application or in a continuing application.

It should be understood that any logic code, programs, modules, processes, and/or methods disclosed herein, along with the order in which the respective elements of any such method are performed, are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment. Additionally, the various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

The phrase “non-transitory,” in addition to having its ordinary meaning, as used in this document means “enduring or long-lived.” The phrase “non-transitory computer readable medium,” in addition to having its ordinary meaning, includes any and all computer readable mediums, with the sole exception of a transitory, propagating signal. This includes, by way of example and not limitation, non-transitory computer-readable mediums such as register memory, processor cache and random-access memory (“RAM”).

The methods as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents are based on the information available to the applicants and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

All of the material in this patent document issue subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What is claimed is:

1. A method for securely creating and managing an at least one financial spreadsheet containing a plurality of cells arranged as a plurality of rows and columns, with each cell containing cell data, the method comprising the steps of:
implementing a user application residing in memory on an at least one computing device, the at least one computing device configured for receiving and processing select data related to the at least one financial spreadsheet; and
for each of the at least one financial spreadsheet:
the user application creating a definition file containing a plurality of lines, with each line corresponding to a row of the financial spreadsheet and containing a line number, a line description, and a row logic to be applied to each cell in the corresponding row of the financial spreadsheet;
the user application storing the definition file;
the user application validating the definition file to confirm that the line number, line description and row logic contained in each line of the definition file uses proper syntax and line references;
upon the user application determining that the line number, line description and row logic contained in each line of the definition file uses proper syntax and line references, the user application saving the definition file as a read-only model file;
the user application creating a data query file containing a plurality of lines, with each line corresponding to a row of the financial spreadsheet and containing a line number and cell data for each cell in the corresponding row of the financial spreadsheet, such that a given line of each of the data query file and definition file corresponding to the same row of the financial spreadsheet shares the same line number;
the user application populating the cell data in the data query file;
the user application storing the data query file;
the user application validating the data query file to confirm that the cell data contained in each line of the data query file is valid;
upon the user application determining that the cell data contained in each line of the data query file is valid, the user application saving the data query file as a read-only data file; and
the user application combining the model file and the data file to create a rendered report file containing a plurality of cells arranged as a plurality of rows and columns, with each row of the rendered report file containing the line number and line description from the corresponding line of the model file, each cell within a given row of the rendered report file containing the cell data from the corresponding line of the data file, and the cell data of each cell within a given row of the rendered report file being modified based on the row logic from the corresponding line of the model file.

2. The method of claim 1, wherein the step of the user application creating a definition file further comprises the step of the user application adding one or more of an internal precision property, an internal rounding property, a totaling control property, a category index property, a number format property, a display control property, a display rounding property, a display scaling property, a display formatting property, and a note field to each line of the definition file.

3. The method of claim 1, wherein the step of the user application populating the cell data in the data query file further comprises the step of the user application allowing a user to manually input the cell data.

4. The method of claim 1, wherein the step of the user application populating the cell data in the data query file further comprises the step of the user application automatically accessing and obtaining the cell data from an at least one data source in selective communication with the at least one computing device.

5. The method of claim 1, further comprising the steps of:
the user application adding to the data query file a data query prolog containing at least one of a spreadsheet title, a spreadsheet time period, and a column heading for each column of the financial spreadsheet; and
the user application adding to the rendered report file the spreadsheet title, spreadsheet time period and column headings from the data query prolog of the data file.

6. The method of claim 1, wherein the step of the user application combining the model file and the data file to create a rendered report file further comprises the step of the user application only displaying lines from the model file containing an operation code that indicates the corresponding line is intended to be displayed.

7. The method of claim 1, further comprising the step of implementing an at least one data storage device in selective communication with the computing device and configured for storing select data related to the at least one financial spreadsheet.

8. A financial spreadsheet modeling system for securely creating and managing an at least one financial spreadsheet containing a plurality of cells arranged as a plurality of rows and columns, with each cell containing cell data, the system comprising:
a computing device configured for receiving and processing select data related to the at least one financial spreadsheet, the computing device containing a user application residing in memory on the computing device and configured for, for each of the at least one financial spreadsheet:
creating a definition file containing a plurality of lines, with each line corresponding to a row of the financial spreadsheet and containing a line number, a line description, and a row logic to be applied to each cell in the corresponding row of the financial spreadsheet;
storing the definition file;
validating the definition file to confirm that the line number, line description and row logic contained in each line of the definition file uses proper syntax and line references;
upon determining that the line number, line description and row logic contained in each line of the definition file uses proper syntax and line references, saving the definition file as a read-only model file;
creating a data query file containing a plurality of lines, with each line corresponding to a row of the financial spreadsheet and containing a line number and cell data for each cell in the corresponding row of the financial spreadsheet, such that a given line of each of the data query file and definition file corresponding to the same row of the financial spreadsheet shares the same line number;
populating the cell data in the data query file;
storing the data query file;
validating the data query file to confirm that the cell data contained in each line of the data query file is valid;
upon determining that the cell data contained in each line of the data query file is valid, saving the data file as a read-only data file; and
combining the model file and the data file to create a rendered report file containing a plurality of cells arranged as a plurality of rows and columns, with each row of the rendered report file containing the line number and line description from the corresponding line of the model file, each cell within a given row of the rendered report file containing the cell data from the corresponding line of the data file, and the cell data of each cell within a given row of the rendered report file being modified based on the row logic from the corresponding line of the model file.

9. The financial spreadsheet modeling system of claim 8, further comprising an at least one data storage device in selective communication with the computing device and configured for storing select data related to the at least one financial spreadsheet.

10. The financial spreadsheet modeling system of claim 8, wherein, while creating a definition file, the user application is further configured for adding one or more of an internal precision property, an internal rounding property, a totaling control property, a category index property, a number format property, a display control property, a display rounding property, a display scaling property, a display formatting property, and a note field to each line of the definition file.

11. The financial spreadsheet modeling system of claim 8, wherein, while populating the cell data in the data query file, the user application is further configured for allowing a user to manually input the cell data.

12. The financial spreadsheet modeling system of claim 8, wherein, while populating the cell data in the data query file, the user application is further configured for automatically accessing and obtaining the cell data from an at least one data source in selective communication with the at least one computing device.

13. The financial spreadsheet modeling system of claim 8, wherein the user application is further configured for:
adding to the data query file a data query prolog containing at least one of a spreadsheet title, a spreadsheet time period, and a column heading for each column of the financial spreadsheet; and
adding to the rendered report file the spreadsheet title, spreadsheet time period and column headings from the data query prolog of the data file.

14. The financial spreadsheet modeling system of claim 8, wherein, while combining the model file and the data file to create a rendered report file, the user application is further configured for only displaying lines from the model file containing an operation code that indicates the corresponding line is intended to be displayed.

15. A non-transitory computer readable medium containing program instructions for causing an at least one computing device to perform a method of securely creating and managing an at least one financial spreadsheet containing a plurality of cells arranged as a plurality of rows and columns, with each cell containing cell data, the method comprising the steps of, for each of the at least one financial spreadsheet:
creating a definition file containing a plurality of lines, with each line corresponding to a row of the financial spreadsheet and containing a line number, a line description, and a row logic to be applied to each cell in the corresponding row of the financial spreadsheet;
storing the definition file;
validating the definition file to confirm that the line number, line description and row logic contained in each line of the definition file uses proper syntax and line references;
upon determining that the line number, line description and row logic contained in each line of the definition file uses proper syntax and line references, saving the definition file as a read-only model file;
creating a data query file containing a plurality of lines, with each line corresponding to a row of the financial spreadsheet and containing a line number and cell data for each cell in the corresponding row of the financial spreadsheet, such that a given line of each of the data query file and definition file corresponding to the same row of the financial spreadsheet shares the same line number;
populating the cell data in the data query file;
storing the data query file;
validating the data query file to confirm that the cell data contained in each line of the data query file is valid;
upon determining that the cell data contained in each line of the data query file is valid, saving the data query file as a read-only data file; and
combining the model file and the data file to create a rendered report file containing a plurality of cells arranged as a plurality of rows and columns, with each row of the rendered report file containing the line number and line description from the corresponding line of the model file, each cell within a given row of the rendered report file containing the cell data from the corresponding line of the data file, and the cell data of each cell within a given row of the rendered report file being modified based on the row logic from the corresponding line of the model file.

16. The method of claim 15, wherein the step of creating a definition file further comprises the step of adding one or more of an internal precision property, an internal rounding property, a totaling control property, a category index property, a number format property, a display control property, a display rounding property, a display scaling property, a display formatting property, and a note field to each line of the definition file.

17. The method of claim 15, wherein the step of populating the cell data in the data query file further comprises the step of allowing a user to manually input the cell data.

18. The method of claim 15, wherein the step of populating the cell data in the data query file further comprises the step of automatically accessing and obtaining the cell data from an at least one data source in selective communication with the at least one computing device.

19. The method of claim 15, further comprising the steps of:
adding to the data query file a data query prolog containing at least one of a spreadsheet title, a spreadsheet time period, and a column heading for each column of the financial spreadsheet; and
adding to the rendered report file the spreadsheet title, spreadsheet time period and column headings from the data query prolog of the data file.

20. The method of claim 15, wherein the step of combining the model file and the data file to create a rendered report file further comprises the step of only displaying lines from the model file containing an operation code that indicates the corresponding line is intended to be displayed.
